(19) United States
(12) Patent Application Publication
(10) Pub. No.: US 2026/0356514 A1
(43) Pub. Date: Nov. 12, 2026

(54) DUAL-PURPOSE BOOT AND METHOD OF MANUFACTURE

(71) Applicant: Perennial Autonomy, LLC, Menlo Park, CA (US)

(72) Inventors: Christian Johan Owen HANDLEY, San Francisco, CA (US); David SCHNELLE, Palo Alto, CA (US); Jaffer ALI, Cleveland, OH (US)

(21) Appl. No.: 19/672,524

(22) Filed: May 8, 2026

Related U.S. Application Data
(63) Continuation-in-part of application No. 19/542,624, filed on Feb. 17, 2026.
(60) Provisional application No. 63/960,687, filed on Jan. 14, 2026.
(60) Provisional application No. 63/910,760, filed on Nov. 3, 2025.
(60) Provisional application No. 63/854,392, filed on Jul. 30, 2025.
(60) Provisional application No. 63/815,810, filed on Jun. 1, 2025.
(60) Provisional application No. 63/807,413, filed on May 16, 2025.
(60) Provisional application No. 63/803,081, filed on May 9, 2025.

(51) Int. Cl. B64U 60/50; B64F 5/10; B64U 10/13; B64U 70/92; B64U 80/40; F16F 1/377

(52) U.S. Cl. CPC B64U 60/50; B64F 5/10; B64U 10/13; B64U 70/92; B64U 80/40; F16F 1/377; F16F 2224/025; F16F 2230/36

(57) ABSTRACT

A dual-purpose boot for a mobile platform is disclosed that includes an engaging portion, a shock absorbing portion, and a shoulder positioned therebetween. The engaging portion includes a first axial opening for receiving an end of a support member, and the shock absorbing portion includes a second axial opening having a width smaller than the first axial opening. The shoulder limits axial insertion of the support member into the second axial opening and the shock absorbing portion includes a plurality of compression cavities configured to deform under axial impact to absorb mechanical energy during landing, stacking, or transport. The first and second axial openings define a passage configured to receive a guide rail, allowing guided movement of the mobile platform during stacking, while a lower surface of the shock absorbing portion engages a landing surface or a support member of another mobile platform to provide impact absorption and stacking stability.

### CROSS-REFERENCE TO RELATED APPLICATION

This non-provisional utility application claims priority to provisional patent application number 63/854,392, entitled “DUAL-PURPOSE BOOT AND METHOD OF MANUFACTURE” and filed on Jul. 30, 2025, provisional patent application number 63/807,413, entitled “LAUNCHING CONTAINER USING SUPPORTS FOR MOBILE PLATFORMS” and filed on May 16, 2025, provisional patent application number 63/803,081, entitled “MOBILE PLATFORM DEPLOYMENT METHOD AND SYSTEM” and filed on May 9, 2025, provisional patent application number 63/815,810, entitled “LAUNCHING CONTAINER ASSEMBLY FOR MOBILE PLATFORMS” and filed on Jun. 1, 2025, provisional patent application number 63/960,687, entitled “CONTAINER ASSEMBLY WITH SECURING MECHANISM” and filed on Jan. 14, 2026, provisional patent application number 63/910,760, entitled “MOBILE PLATFORM STACKING ASSEMBLY” and filed on Nov. 3, 2025, non-provisional patent application number 19/542,624, entitled “STACKING SPACER FOR MOBILE PLATFORMS” and filed on Feb. 17, 2026, each of which is incorporated herein in its entirety by reference.

### BACKGROUND

Mobile platforms may be transported or arranged in stacked configurations. During such operations, portions of a mobile platform may contact the ground or another surface, damaging the mobile platform.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

Systems and methods for a dual-purpose boot are provided. The dual-purpose boot includes an engaging portion comprising a first axial opening having a first width. The first axial opening has a first length extending from a first end of the engaging portion to a second end of the engaging portion opposite the first end of the engaging portion. The dual-purpose boot further includes a shock absorbing portion comprising a second axial opening having a second width that is shorter than the first width. The second axial opening has a second length extending from a first end of the shock absorbing portion to a second end of the shock absorbing portion opposite the first end of the shock absorbing portion. The shock absorbing portion further comprises a plurality of compression cavities, each of the plurality of compression cavities being deformable between a first height in an uncompressed state and a second height in a compressed state with the second height being smaller than the first height. The dual-purpose boot further includes a shoulder positioned between the second end of the engaging portion and the first end of the shock absorbing portion with the shoulder extending laterally from a first perimeter of the first axial opening to a second perimeter of the second axial opening. The shoulder is positioned to contact a bottom end of a support member of a mobile platform, and an end of the support member has a third width that is larger than the second width and smaller than the first width.

### BRIEF DESCRIPTION OF THE DRAWINGS

The present description will be better understood from the following detailed description read considering the accompanying drawings, wherein:

FIGS. 1 and 2 are perspective views illustrating an example dual-purpose boot;

FIGS. 3A and 3B illustrate an example shock absorbing portion;

FIG. 4 illustrates an example of a stacking of mobile platforms with dual-purpose boots;

FIG. 5 is a perspective view illustrating an example dual-purpose boot engaging a supporting member; and

FIG. 6 is a flowchart illustrating an exemplary method for manufacturing a dual-purpose boot.

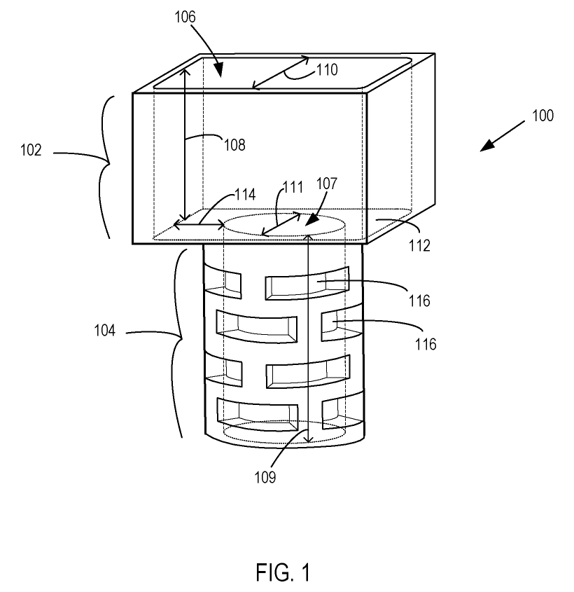

Corresponding reference characters indicate corresponding parts throughout the drawings. In FIGS. 1 - 6, the systems are illustrated as schematic drawings. The drawings may not be to scale. Any of the figures may be combined into a single example or embodiment.

### DETAILED DESCRIPTION

The present disclosure describes a dual-purpose boot for use with a mobile platform. In some embodiments, the boot is configured to be coupled to a support member of the mobile platform and to provide both an engagement interface and a shock-absorbing interface. The boot may be used during operations in which the mobile platform is landed, handled, transported, stored, stacked, or otherwise positioned relative to another platform or support structure.

In some embodiments, the boot includes an engaging portion, a shock absorbing portion, and a shoulder positioned between the engaging portion and the shock absorbing portion. The engaging portion defines a first axial opening configured to receive an end of the support member. The shock absorbing portion defines a second axial opening having a smaller width than the first axial opening and includes a plurality of compression cavities configured to deform under load. The shoulder extends between the first axial opening and the second axial opening and is positioned to contact a bottom end of the support member, thereby locating the boot relative to the support member while permitting the shock absorbing portion to compress in response to an applied force.

As described in further detail herein, the boot may provide contact, support, shock absorption, positioning, or stacking functionality through an integrated structure. For example, the relative sizing of the axial openings, the placement of the shoulder, and the deformable compression cavities allows the boot to remain engaged with the support member while absorbing forces associated with landing, stacking, handling, storage, or transport of the mobile platform.

In some examples, the system utilizes thermoplastic polyurethane (TPU) for the construction of the shock absorbing components (e.g., dual-purpose boots) described herein, a material choice that is not commonly found in existing general stacking systems. TPU's low Young's modulus and specific Shore hardness provide a balance between flexibility and durability, which is particularly advantageous for absorbing impact forces during landings as well as stacking.

Example dual-purpose boots described herein include a slotted spring design within the dual-purpose boot, enhancing impact absorbing by allowing controlled deformation. This design distributes impact forces over a larger area and increases a time over which deceleration occurs.

In addition, examples of the system use an interference fit for the dual-purpose boots to allow for easy attachment and detachment, facilitating maintenance and quick replacement. The modular approach described herein is specifically optimized to ensure that the dual-purpose boots remain with the mobile platform during takeoff.

Furthermore, the dual-purpose boots described herein are optimized for specific weight and drop height parameters, such as absorbing an impact of a 5-kilogram mobile platform dropped from a height of one meter during the stacking process. This level of optimization for specific conditions unique to a particular object, such as a mobile platform, is not found in prior art related to general stacking systems or landing mechanisms.

Aspects of the disclosure are operable in a wide range of applications outside of mobile platforms. For example, the dual-purpose boots described herein can be designed and used specifically for a variety of components, such as tripod-mounting devices, portable generators and compressors, stackable storage racks, pallets systems or dollies, kickstands on motorcycles and bicycles, roof racks, furniture legs, appliance, audio systems/speakers, crutches, walkers, and canes.

An example implementation of the dual-purpose boot features two separate portions, an engaging portion and a shock absorbing portion, which are monolithically formed from elastomeric material. The engaging portion is design to receive an end of a support member of the mobile platform within an axial opening of the engaging portion (e.g., like a boot), while a shoulder positioned between the engaging portion and the shock absorbing portion prevents the support member from moving into an axial opening of the shock absorbing portion, which has width shorter than width of the axial opening of the engaging portion. Thus, a top portion of the dual-purpose boot (e.g., the engaging portion) is designed to secure the dual-purpose boot to the end of the support member while the bottom portion of the dual-purpose boot is designed to provide impact absorbing. To enhance impact absorption unique to both landing and stacking, the shock absorbing portion includes a plurality of lateral compression cavities in a sidewall of the shock absorbing portion, with a location and size of each of the compression cavities being specific to the impact and vibrations the mobile platform experiences during landings and stackings.

While described for convenience in the context of two dual-purpose boots located at a bottom of respective support members of a mobile platform, aspects of the disclosure are operable with any quantity and size of dual-purpose boots. For example, the same dual-purpose boots at the bottom end of the support members can also be attached to an opposite top end of the support members, further enhancing absorbing during stacking or even crash landings.

In one implementation, a mobile platform landing and stacking mechanism comprises a stacked system configured to accommodate a plurality of mobile platforms in a vertical arrangement. Each mobile platform is equipped with dual-purpose boots constructed from a 3D printable TPU material, characterized by a Shore hardness of approximately 85, which provides a balance between flexibility and durability. The dual-purpose boots are advantageously designed to absorb impact forces during landing and stacking thereby mitigating potential damage to the drone structure.

In another implementation, the dual-purpose boots feature a slotted spring design that enhances impact absorbing capabilities. The slots are strategically positioned to allow for controlled deformation, distributing impact forces over a larger area and increasing a time over which deceleration occurs. This design ensures that the dual-purpose boots do not bottom out or yield, allowing for repeated use over multiple landing and stacking cycles.

In yet another implementation, the dual-purpose boots are designed to slide over support members of the mobile platform’s landing gear using an interference fit. This modular design facilitates easy attachment and detachment, allowing for straightforward maintenance and replacement. The interference fit ensures that the dual-purpose boots remain securely attached to the mobile platform during takeoff from the stack, preventing interference with other mobile platforms in the stack.

In a further implementation, the dual-purpose boots are optimized to absorb an impact of a 5-kilogram mobile platform dropped from a height of one meter. The geometry of the dual-purpose boots is specifically designed to ensure that faces of the slotted spring contact each other before the material yields, acting as a strain limiter and preventing material failure. While the 5-kilogram weight at the height of one meter is specific to the implementations described herein, wherein each mobile platform in a stack weighs 5-kilograms and each mobile platform is dropped from a height of one meter or less during stacking, other weights and heights are contemplated herein, whereby the dual-purpose boots are designed specifically for a different particular weight and/or a different particular drop height.

In an additional implementation, the system includes one-time use crushable materials, such as aluminum or paper honeycomb, bubble wrap, foams, or 3D-printed crush structures in place of or integrated into the shock absorbing portion of the dual-purpose boots to achieve similar deceleration effects. These materials may be integrated to optimize weight, height, and material usage while maintaining impact absorbing capabilities.

An exemplary technical effect of the system, apparatus, and methods described herein with respect to the dual-purpose boots is the provision of both impact absorbing during landing and structural support for stable stacking during transport or storage. Each dual-purpose boot is positioned at the lower end of a corresponding support member and is formed from a resilient (or crushable) material configured to deform under landing forces, thereby reducing the transmission of shock to the mobile platform body and sensitive onboard components. In addition to mitigating landing impact, the dual-purpose boots include a uniquely contoured lower surface with an ability to support multiple operational modes, such as landing, stacking, and guided alignment within a single integrated structure. The lower surface of the shock absorbing portion includes an opening or channel dimensioned to receive and slide along a vertically oriented stacking beam, thereby facilitating self-aligning engagement during storage or transport. Simultaneously, the lower surface is shaped to mechanically engage with an upper portion of a support member of a lower mobile platform, enabling stable and secure vertical stacking with minimal lateral movement, while also providing the necessary absorbing. Additionally, an outermost portion of the lower surface includes a flat landing interface, optimized to provide a stable contact footprint during a mobile platform’s descent and ground contact. This multifunctional design of the dual-purpose boot enhances the operational robustness of the mobile platform by reducing the need for separate cushioning and stacking components, streamlining deployment, improving durability during handling, conserving space during storage or bulk transport, reduces part count and assembly complexity, and enhances both the robustness and operational efficiency of the mobile platform system across different use cases.

Referring now to FIG. 1, a perspective view illustrating an example dual-purpose boot 100 is provided. The dual-purpose boot 100 includes two separate sections, engaging portion 102 and shock absorbing portion 104. While described herein as two separate sections, in some examples, an entirety of dual-purpose boot 100 is monolithically formed from elastomeric material. In some examples, the elastomeric material is natural rubber, styrene-butadiene rubber, nitrile rubber, ethylene propylene diene monomer, silicon rubber, butyl rubber, thermoplastic polyurethane, thermoplastic vulcanizates, thermoplastic rubber, neoprene, polyisoprene, and the like. In some examples, the dual-purpose boot 100 has a length of approximately 150 millimeters, a width of approximately 80 millimeters, and a height of approximately 50 millimeters. In some examples, these dimensions are selected to ensure compatibility with the mobile platform’s landing gear and to provide sufficient surface area for effective impact absorption. In some examples, in relative terms, the dual-purpose boot’s 100 dimensions are proportionate to a size of the landing gear (e.g., the support members) of the mobile platform, ensuring a snug fit that facilitates an interference fit mechanism. In some examples, a length of the dual-purpose boot 100 is approximately twice the width of the metal bars of the landing gear, allowing for adequate coverage and secure attachment. In some examples, a height of the dual-purpose boot 100 is designed to be approximately one-third of its length, providing a compact form factor that maintains the mobile platform’s aerodynamic profile while offering sufficient material volume for the incorporation of the slotted spring design. In some examples, a thickness of an outer wall of the dual-purpose boot 100 is approximately 5 millimeters to balance flexibility and structural integrity, allowing for controlled deformation under load conditions without compromising durability.

In some examples, the engaging portion 102 includes an axial opening (e.g., a first axial opening 106) that extends from a top of the engaging portion 102 to a bottom of the engaging portion 102 as represented by arrow 108 and the shock absorbing portion 104 includes an axial opening (e.g., a second axial opening 107) that extends from a bottom of a top of the shock absorbing portion 104 to a bottom of the shock absorbing portion 104 as represented by arrow 109.

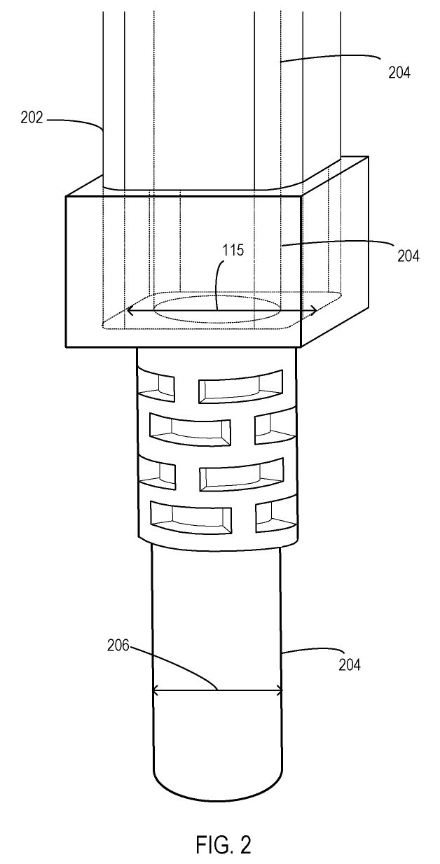

The first axial opening 106 is sized and shaped to receive an end of a support member, such as support member 202 shown in FIG. 2. While standard or basic shapes of the first axial opening 106 are contemplated herein, in some examples, the shape of the first axial opening 106 is specific to the shape of the support member that will extend through the first axial opening 106 to enable a better and/or tighter fit. In some examples, the dual-purpose boot 100 is attached to the support member 202 through the use of an interference fit mechanism. This design enables the dual-purpose boot 100 to slide over the support member 202, ensuring a secure attachment. The interference fit is achieved by designing the internal dimensions of the dual-purpose boot 100 (e.g., the first axial opening 106) to be slightly smaller in width than the external dimensions of the support member 202, creating a tight fit that holds the boots in place. This method facilitates easy attachment and detachment, allowing for straightforward maintenance and replacement while ensuring that the dual-purpose boot 100 remains securely attached during takeoff and landing operations. Additionally, the modular nature of this attachment system allows for potential integration with other mobile platform components. In some examples, the dual-purpose boot 100 is integrated into the support member 202 itself instead of being attachable and/or removable.

A lower surface of the first axial opening 106 includes a shoulder 112 that defines an area (e.g., represented by arrow 114) extending laterally between a perimeter of the first axial opening 106 and a perimeter of the second axial opening 107. In some examples, the shoulder 112 is sized to limit axial insertion of the support member 202 by preventing the support member 202 from entering the second axial opening 107. That is, the first axial opening 106 has a width (e.g., a first width 110) that is wider than a width (e.g., a second width 111) of the second axial opening 107, and the support member 202 has a width (e.g., a third width 115 shown in FIG. 2) that is less than or equal to the first width 110 and greater than the second width 111. Thus, as the support member 202 extends through the first axial opening 106, a bottom surface of the support member 202 engages the shoulder 112 and is prevented from extending any further (as further illustrated in FIG. 2).

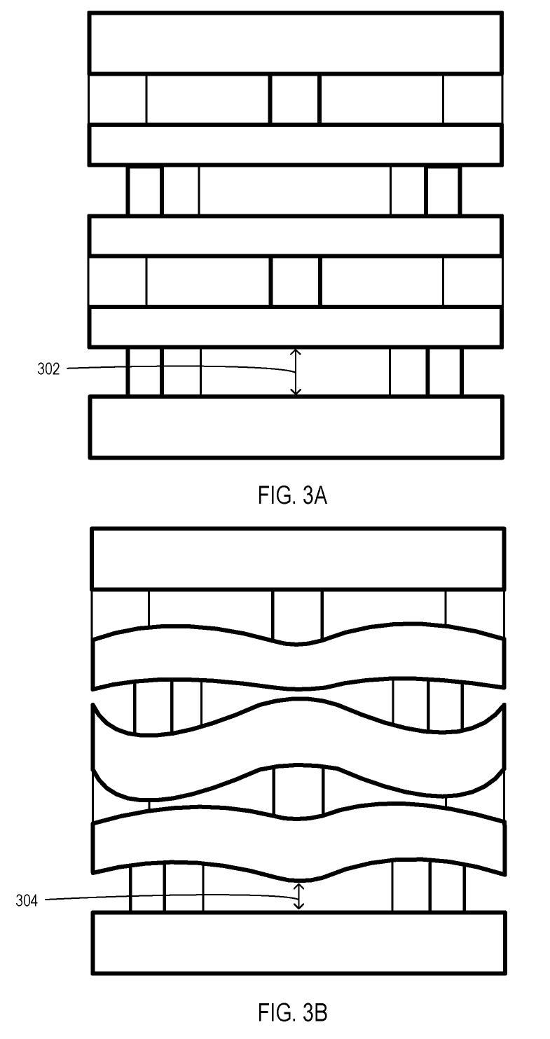

In some examples, the shock absorbing portion 104 includes a plurality of compression cavities 116 formed in a side wall of the shock absorbing portion 104. In some examples, each of the plurality of compression cavities 116 are deformable between a first height in an uncompressed state and a second height in a compressed state. For example, with reference now to FIGS. 3A and 3B, FIG. 3A illustrates the shock absorbing portion 104 in an uncompressed state in a slotted spring design. As such, as shown in FIG. 3A, each of the plurality of compression cavities 116 have a first height represented by arrow 302. FIG. 3B illustrates the shock absorbing portion 104 in the slotted spring design in a compressed state. As such, each of the plurality of compression cavities 116 now have a height smaller than the first height as represented by arrow 304. As shown in FIG. 3B, each of the plurality of compression cavities 116 have different compressed heights given their different sizes, locations, and shapes.

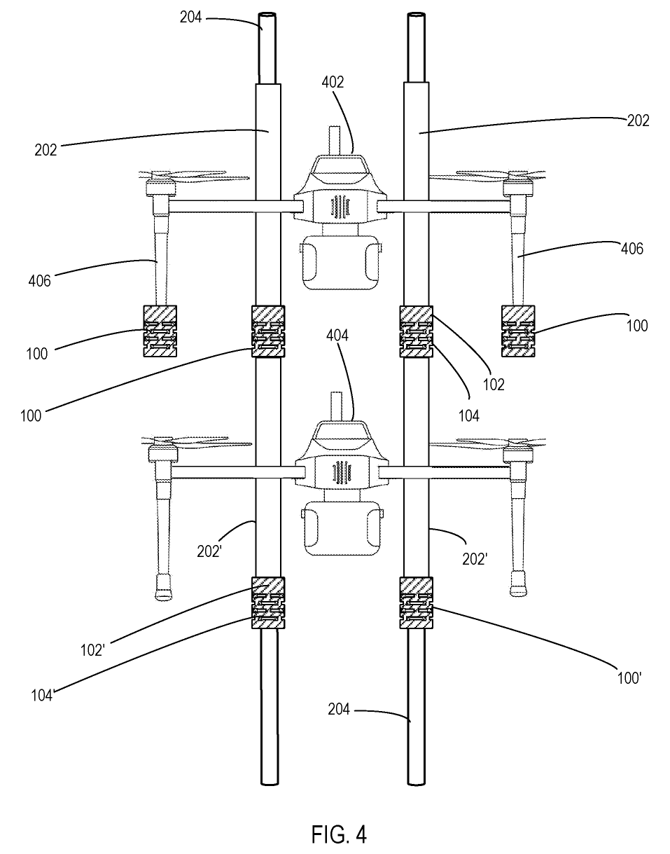

In some examples, the dual-purpose boot 100, and more specifically, the shock absorbing portion 104, is optimized to absorb an impact of a 5-kilogram mobile platform dropped from a height of one meter. Thus, in this example, each mobile platform in a stack weighs 5-kilograms and each mobile platform is dropped from a height of one meter or less during stacking of mobile platforms as shown in FIG. 4. Thus, the shock absorbing portion 104 is configured to absorb at least 49 joules of mechanical energy when subjected to axially loading. While the 5-kilogram weight at the height of one meter are just one specific set of parameters, other weights and heights are contemplated herein, whereby the dual-purpose boot 100 and/or the shock absorbing portion 104 are designed specifically for a different particular weight, a different particular drop height, and/or a different absorbent threshold number of joules of mechanical energy.

In some examples, each of the compression cavities 116 have a width of approximately 5 millimeters, a length of approximately 20 millimeters, and a depth of approximately 10 millimeters to ensure that the compression cavities 116 provide sufficient pathways for controlled deformation of the dual-purpose boot 100 material under load conditions. In some examples, the compression cavities 116 are incorporated into the slotted spring design of the shock absorbing portion 104 are dimensioned in relative terms to optimize impact absorption capabilities. In some examples, a width of each of the compression cavities 116 is approximately one-tenth of the dual-purpose boot’s 100 overall width, allowing for adequate flexing of the material. In some examples, a length of the compression cavities 116 is approximately one-fourth of the dual-purpose boot’s 100 length, ensuring sufficient pathways for controlled deformation. In some examples, a depth of the compression cavities 116 is approximately one-fifth of the dual-purpose boot's 100 height, contributing to the distribution of impact forces over a larger area. In some examples, these relative dimensions are selected to ensure that the compression cavities 116 provide effective deformation characteristics, increasing a time over which deceleration occurs and reducing the instantaneous G-forces experienced by the mobile platform during landing and/or stacking.

In some examples, the compression cavities 116 are configured in various shapes, such as circular, elliptical, or triangular, to modify deformation characteristics. In some examples, circular slots provide uniform stress distribution, while elliptical slots offer directional flexibility, enhancing impact absorption in specific directions. In some examples, triangular slots concentrate deformation at specific points, allowing for targeted energy absorption. In some examples, a staggered pattern for the compression cavities 116 provides uniform deformation across the spring, while a linear arrangement focuses energy absorption along a specific axis. In some examples, varying a density of the compression cavities 116, with more slots in high-stress areas and fewer in low-stress regions, optimizes material usage and performance. In some examples, in addition to or in place of the compression cavities 116, the shock absorbing portion 104 incorporates additional damping elements, such as viscoelastic materials or fluid-filled chambers, to further enhance impact absorption. In some examples, these additional damping elements are strategically placed within or adjacent to the compression cavities 116 to provide additional energy dissipation and reduce rebound effects during landing and stacking.

In some examples, the shock absorbing portion 104 includes removable or adjustable inserts within the compression cavities 116. In some examples, these inserts are made from materials with varying stiffness or damping properties. By changing which inserts are removed and/or adjusted, an overall flexibility and force absorption of the dual-purpose boot 100 can be modified on the fly without requiring obtaining another dual-purpose boot 100 with the needed and/or desired design of the compression cavities 116.

With continued reference to FIGS. 3A and 3B, the color gradient depicted therein represents the stress distribution across the slotted spring design. Areas of higher stress are indicated by warmer colors, while cooler colors denote regions of lower stress. This visualization provides an understanding of how the slotted spring design manages impact forces, ensuring that the material does not yield or bottom out under pressure. This visualization also demonstrates how the slotted design facilitates gradual deceleration by allowing the material to flex and absorb energy over an extended period, thereby reducing the instantaneous G-forces experienced by the drone. The slotted spring design ensures that the faces of the plurality of compression cavities 116 contact each other before the material reaches its yield point, acting as a strain limiter and contributing to the reusability of the dual-purpose boots 100 over multiple landing and stacking cycles.

The modular nature of the slotted spring design, as shown in the examples of FIGS. 3A and 3B, allows for potential variations in compression cavity size, shape, and arrangement to accommodate different mobile platform weights and landing conditions. For example, heavier mobile platforms require larger and/or deeper slots to accommodate greater deformation and energy absorption, ensuring that the material can flex sufficiently to distribute impact forces over a larger area. This adaptability ensures that the dual-purpose boots 100 can be optimized for specific applications, providing a balance between flexibility, impact absorption, and durability. The use of TPU material, characterized by its low Young's modulus and Shore hardness of approximately 85, further enhances the performance of the slotted spring design by allowing significant deflection without permanent deformation.

With reference back to FIG. 2, in some examples, the first axial opening 106 and the second axial opening 107 define a continuous axial passage sized to allow axial movement of a guide rail 204 therethrough. For example, with reference now to FIG. 4, an illustration of a stacking of two mobile platforms 402 and 404 is provided. As shown in FIG. 4, two guide rails 204 extend vertically (e.g., from the ground, a platform, or a case) enabling the support members 202 of the first mobile platform 402 and the support members 202’ of the second mobile platform 404 to slide over a top of (e.g., down) the guide rails 204. In some examples, the guide rails 204 have a width (e.g., a fourth width 206 shown in FIG. 2) that is less than or equal to the second width 111 of the second axial opening 107 of the shock absorbing portion 104, and thus also less than the first width 110 of the first axial opening 106 of the engaging portion 102. As such, the guide rails 204 are enabled to extend all the way through the support members 202, and the first axial openings 106 of the engaging portions 102 and the second axial openings 107 of the shock absorbing portions 104 of each of the dual-purpose boots 100 of the first mobile platform 402, and continue to extend through the support members 202’, and the first axial opening 106’ and the second axial opening 107’ of the second mobile platform 404.

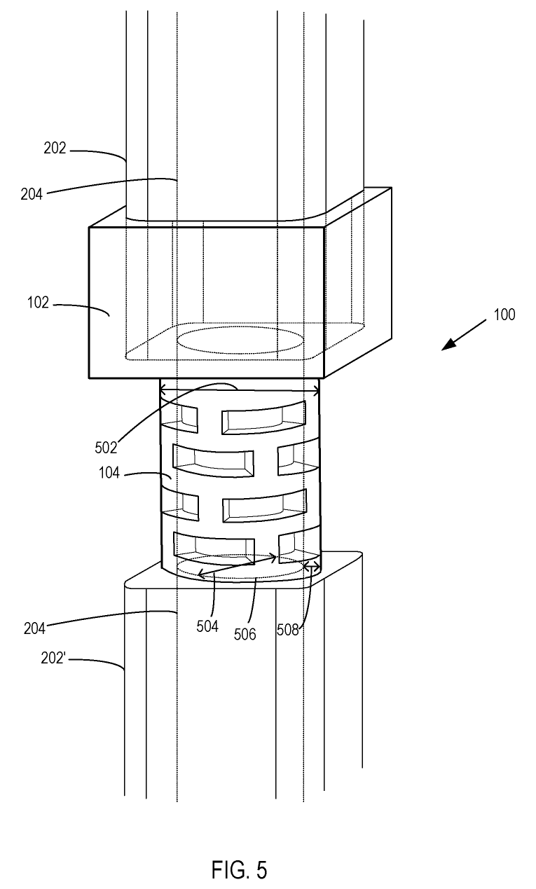

Further, as shown in the example of FIG. 4, the first mobile platform 402 has the dual-purpose boots 100 attached to each end of the supporting members 202. Thus, as the first mobile platform 402 is slid down the guide rails 204, the dual-purpose boots 100 on the supporting members 202 of the first mobile platform 402 engage a top surface of the supporting members 202’ of the second mobile platform 404. More specifically, and with reference to FIG. 5, a bottom surface (e.g., a second surface) of the shock absorbing portion 104 engages a top portion of the supporting member 202’, causing the shock absorbing portion 104 to absorb the impact created from the first mobile platform 402 being slid down the guide rails 204 and on top of (e.g., stacked) the second mobile platform 404. As described above, the shock absorbing portion 104 has the second axial opening 107 extending therethrough, enabling the guide rail 204 to pass all the way through the second axial opening 107. However, a width (e.g., a fifth width 502) of the shock absorbing portion 104 is larger than a width (e.g., a sixth width 504) of an opening 506 at a top of the supporting member 202’ in which the guide rail 204 extends through. Thus, an area (represented by arrow 508) extending between a perimeter of the second axial opening 107 and a perimeter of the shock absorbing portion 104, creates a surface that engages the supporting member 202’.

In some examples, when the first mobile platform 402 is not being stacked and since the dual-purpose boots 100 are attached to a bottom of the supporting members 202 of the first mobile platform 402, the first mobile platform 402 can utilize the dual-purpose boots 100 as “landing gear” as the area 508 on the bottom surface of the shock absorbing portion 104 engages the ground (or any other surface) when landing or simply sitting at rest, enabling the shock absorbing portion 104 to absorb any impact or vibrations resulting therefrom. In this example, and as shown with reference to the first mobile platform 402, the first mobile platform 402 includes additional dual-purpose boots 100 on, for example, each landing leg 406 in addition to the dual-purpose boots 100 on the supporting members 202. In some examples, a length of the landing legs 406 extending downward from a lower surface of the first mobile platform 402 are a same length as the supporting members 202 extending downward from the lower surface of the first mobile platform 402. As such, each of the dual-purpose boots 100 on the landing legs 406 and the supporting members 202 contact a landing surface (e.g., the ground) at a same time. In some examples, the length of the landing legs 406 extending downward from a lower surface of the first mobile platform 402 is longer than the length of the supporting members 202 extending downward from a lower surface of the first mobile platform 402. As such, the dual-purpose boots 100 on the landing legs 406 contact the landing surface while the dual-purpose boots on the supporting members 202 do not.

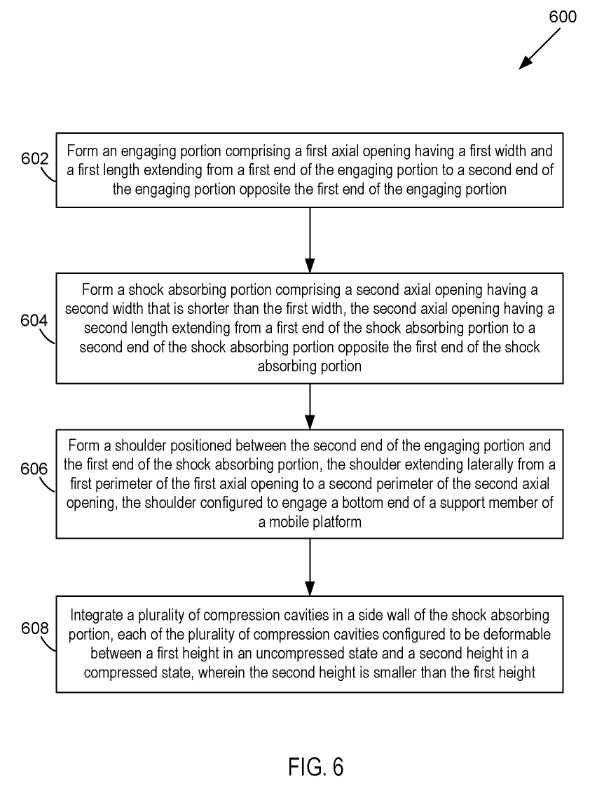

With reference now to FIG. 6, an example method 600 of manufacturing the dual-purpose boot 100 is provided. At 602, an engaging portion (e.g., the engaging portion 102) comprising a first axial opening (e.g., the first axial opening 106) having a first width and a first length extending from a first end of the engaging portion 102 to a second end of the engaging portion 102 opposite the first end of the engaging portion 102 is formed. At 604, a shock absorbing portion (e.g., the shock absorbing portion 104) comprising a second axial opening (e.g., the second axial opening 107) having a second width that is shorter than the first width is formed. The second axial opening 107 is formed having a second length extending from a first end of the shock absorbing portion 104 to a second end of the shock absorbing portion 104 opposite the first end of the shock absorbing portion 104. At 604, a shoulder (e.g., the shoulder 112) positioned between the second end of the engaging portion 102 and the first end of the shock absorbing portion 104 is formed. The shoulder 112 is formed to extend laterally from a first perimeter of the first axial opening 106 to a second perimeter of the second axial opening 107 to enable the shoulder 112 to engage a bottom end of a support member of a mobile platform. At 606, a plurality of compression cavities (the compression cavities 116) is integrated into a side wall of the shock absorbing portion 104. Each of the plurality of compression cavities 116 are formed to be deformable between a first height in an uncompressed state and a second height in a compressed state, wherein the second height is smaller than the first height.

In some examples, a dual-purpose boot includes the following: an engaging portion comprising a first axial opening having a first width, the first axial opening having a first length extending from a first end of the engaging portion to a second end of the engaging portion opposite the first end of the engaging portion; a shock absorbing portion comprising a second axial opening having a second width that is shorter than the first width, the second axial opening having a second length extending from a first end of the shock absorbing portion to a second end of the shock absorbing portion opposite the first end of the shock absorbing portion, the shock absorbing portion further comprising a plurality of compression cavities, each of the plurality of compression cavities being deformable between a first height in an uncompressed state and a second height in a compressed state, wherein the second height is smaller than the first height; and a shoulder positioned between the second end of the engaging portion and the first end of the shock absorbing portion, the shoulder having a ledge extending laterally from a first perimeter of the first axial opening to a second perimeter of the second axial opening, the ledge positioned to contact a bottom end of a support member of a mobile platform, the end of the support member having a third width that is larger than the second width and smaller than the first width.

In some examples, a method of manufacturing a dual-purpose boot includes the following operations: forming, from a single piece of elastomeric material: an engaging portion comprising a first axial opening having a first width and a first length extending from a first end of the engaging portion to a second end of the engaging portion opposite the first end of the engaging portion; a shock absorbing portion comprising a second axial opening having a second width that is shorter than the first width, the second axial opening having a second length extending from a first end of the shock absorbing portion to a second end of the shock absorbing portion opposite the first end of the shock absorbing portion; and a shoulder positioned between the second end of the engaging portion and the first end of the shock absorbing portion, the shoulder having a ledge extending laterally from a first perimeter of the first axial opening to a second perimeter of the second axial opening, the ledge configured to engage a bottom end of a support member of a mobile platform; and integrating a plurality of compression cavities in a side wall of the shock absorbing portion, each of the plurality of compression cavities configured to be deformable between a first height in an uncompressed state and a second height in a compressed state, wherein the second height is smaller than the first height.

In some examples, a dual-purpose boot includes the following: an engaging portion comprising a first axial opening having a first width; a shock absorbing portion comprising a second axial opening having a second width that is shorter than the first width, the shock absorbing portion further comprising a plurality of lateral compression cavities configured to deform in a compressed state under axial impact; and a shoulder positioned between the engaging portion and the shock absorbing portion, wherein the shoulder is configured to limit axial insertion of a support member by preventing the support member from entering the second axial opening; wherein the first axial opening and the second axial opening are configured to allow axial movement of a guide rail therethrough, the end of the support member having a third width that is larger than the second width and smaller than the first width.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms "comprising," "including," and "having" are intended to be inclusive and mean that there can be additional elements other than the listed elements. In other words, the use of "including," "comprising," "having," "containing," "involving," and variations thereof, is meant to encompass the items listed thereafter and additional items. Accordingly, and for example, unless explicitly stated to the contrary, implementations "comprising" or "having" an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles "a," "an," "the," and "said" are intended to mean that there are one or more of the elements. In other words, the indefinite articles "a", “an”, “the”, and “said” as used in the specification and in the claims, unless clearly indicated to the contrary, should be understood to mean "at least one." Accordingly, and for example, as used herein, an element or step recited in the singular and preceded by the word "a" or "an" should be understood as not necessarily excluding the plural of the elements or steps.

The phrase “one or more of the following: A, B, and C” means “at least one of A and/or at least one of B and/or at least one of C." The phrase "and/or", as used in the specification and in the claims, should be understood to mean "either or both" of the elements so conjoined, i.e., elements that are conjunctively present in some cases and disjunctively present in other cases. Multiple elements listed with "and/or" should be construed in the same fashion, i.e., "one or more" of the elements so conjoined. Other elements may optionally be present other than the elements specifically identified by the "and/or" clause, whether related or unrelated to those elements specifically identified. Thus, as a non-limiting example, a reference to "A and/or B", when used in conjunction with open-ended language such as "comprising" can refer, in one implementation, to A only (optionally including elements other than B); in another implementation, to B only (optionally including elements other than A); in yet another implementation, to both A and B (optionally including other elements); etc.

As used in the specification and in the claims, "or" should be understood to have the same meaning as "and/or" as defined above. For example, when separating items in a list, "or" or "and/or" shall be interpreted as being inclusive, i.e., the inclusion of at least one, but also including more than one, of a number or list of elements, and, optionally, additional unlisted items. Only terms clearly indicated to the contrary, such as "only one of or "exactly one of," or, when used in the claims, "consisting of," will refer to the inclusion of exactly one element of a number or list of elements. In general, the term "or" as used shall only be interpreted as indicating exclusive alternatives (i.e., "one or the other but not both") when preceded by terms of exclusivity, such as "either," "one of' "only one of' or "exactly one of." "Consisting essentially of," when used in the claims, shall have its ordinary meaning as used in the field of patent law.

As used in the specification and in the claims, the phrase "at least one," in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase "at least one" refers, whether related or unrelated to those elements specifically identified. Thus, as a non-limiting example, "at least one of A and B" (or, equivalently, "at least one of A or B," or, equivalently "at least one of A and/or B") can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A dual-purpose boot comprising:
an engaging portion comprising a first axial opening having a first width, the first axial opening having a first length extending from a first end of the engaging portion to a second end of the engaging portion opposite the first end of the engaging portion;
a shock absorbing portion comprising a second axial opening having a second width that is shorter than the first width, the second axial opening having a second length extending from a first end of the shock absorbing portion to a second end of the shock absorbing portion opposite the first end of the shock absorbing portion, the shock absorbing portion further comprising a plurality of compression cavities, each of the plurality of compression cavities being deformable between a first height in an uncompressed state and a second height in a compressed state, wherein the second height is smaller than the first height; and
a shoulder positioned between the second end of the engaging portion and the first end of the shock absorbing portion, the shoulder extending laterally from a first perimeter of the first axial opening to a second perimeter of the second axial opening, the shoulder positioned to contact a bottom end of a support member of a mobile platform, an end of the support member having a third width that is larger than the second width and smaller than the first width.

2. The dual-purpose boot of claim 1, wherein the first axial opening and the second axial opening define a continuous axial passage sized to allow axial movement of a guide rail therethrough, the guide rail having a fourth width that is smaller than the second width of the second axial opening.

3. The dual-purpose boot of claim 1, wherein the shoulder is sized to limit axial insertion of the support member by preventing the support member from entering the second axial opening.

4. The dual-purpose boot of claim 1, wherein the plurality of compression cavities are lateral cavities formed in a side wall of the shock absorbing portion.

5. The dual-purpose boot of claim 1, wherein the second end of the shock absorbing portion defines an interface surface that bears against a landing surface or a top end of a second support member of a second mobile platform.

6. The dual-purpose boot of claim 1, wherein the engaging portion and the shock absorbing portion are formed from a single, continuous piece of elastomeric material.

7. The dual-purpose boot of claim 1, wherein the shock absorbing portion absorbs at least 49 joules of mechanical energy when subjected to axially loading.

8. A method of manufacturing a dual-purpose boot, the method comprising:
forming, from a single piece of elastomeric material:
an engaging portion comprising a first axial opening having a first width and a first length extending from a first end of the engaging portion to a second end of the engaging portion opposite the first end of the engaging portion;
a shock absorbing portion comprising a second axial opening having a second width that is shorter than the first width, the second axial opening having a second length extending from a first end of the shock absorbing portion to a second end of the shock absorbing portion opposite the first end of the shock absorbing portion; and
a shoulder positioned between the second end of the engaging portion and the first end of the shock absorbing portion, the shoulder extending laterally from a first perimeter of the first axial opening to a second perimeter of the second axial opening, the shoulder configured to engage a bottom end of a support member of a mobile platform; and
integrating a plurality of compression cavities in a side wall of the shock absorbing portion, each of the plurality of compression cavities configured to be deformable between a first height in an uncompressed state and a second height in a compressed state, wherein the second height is smaller than the first height.

9. The method of claim 8, wherein the engaging portion and the shock absorbing portion are formed to enable a guide rail to slide therethrough, the guide rail having a fourth width that is smaller than the second width of the second axial opening.

10. The method of claim 8, wherein the shoulder is formed to limit axial insertion of the support member from entering the second axial opening.

11. The method of claim 8, wherein the plurality of compression cavities are lateral cavities formed in the side wall of the shock absorbing portion.

12. The method of claim 8, wherein the shock absorbing portion is configured to absorb a defined threshold of mechanical energy resulting from axial impact.

13. The method of claim 12, wherein the shock absorbing portion is configured to absorb at least 49 joules of mechanical energy applied axially.

14. The method of claim 8, further comprising:
receiving an indication that the shock absorbing portion is to absorb at least 49 joules of mechanical energy applied axially; and
based on the received indication:
determining a size, shape, and location of each of the plurality of compression cavities in the side wall of the shock absorbing material; and
determining a length of the second length of the second axial opening.

15. A dual-purpose boot comprising:
an engaging portion comprising a first axial opening having a first width;
a shock absorbing portion comprising a second axial opening having a second width that is shorter than the first width, the shock absorbing portion further comprising a plurality of lateral compression cavities configured to deform in a compressed state under axial impact; and
a shoulder positioned between the engaging portion and the shock absorbing portion, wherein the shoulder is configured to limit axial insertion of a support member by preventing the support member from entering the second axial opening;
wherein the first axial opening and the second axial opening are configured to allow axial movement of a guide rail therethrough, an end of the support member having a third width that is larger than the second width and smaller than the first width.

16. The dual-purpose boot of claim 15, wherein the engaging portion and the shock absorbing portion are configured to enable a guide rail to slide therethrough, the guide rail having a fourth width that is smaller than the second width of the second axial opening.

17. The dual-purpose boot of claim 15, wherein an end of the shock absorbing portion is configured to engage a landing surface.

18. The dual-purpose boot of claim 15, wherein an end of the shock absorbing portion is configured to engage a top end of a second support member.

19. The dual-purpose boot of claim 15, wherein the shock absorbing portion is configured to absorb at least 49 joules of mechanical energy applied axially.

20. The dual-purpose boot of claim 15, wherein the engaging portion and the shock absorbing portion are configured to be made from a single piece of material.
